(19) United States
(12) Patent Application Publication
(10) Pub. No.: US 2024/0086863 A1
(43) Pub. Date: Mar. 14, 2024

(54) VEHICLE REPAIR ESTIMATION WITH REVERSE IMAGE MATCHING AND ITERATIVE VECTORIZED CLAIM REFINEMENT

(71) Applicant: Mitchell International, Inc., San Diego, CA (US)

(72) Inventors: Abhijeet Gulati, San Diego, CA (US); Michael Apers, San Diego, CA (US)

(73) Assignee: Mitchell International, Inc., San Diego, CA (US)

(21) Appl. No.: 18/233,232

(22) Filed: Aug. 11, 2023

Related U.S. Application Data
(60) Provisional application No. 63/405,766, filed on Sep. 12, 2022.

(51) Int. Cl. G06Q 10/20; G06Q 40/08; G06V 10/74

(52) U.S. Cl. CPC G06Q 10/20; G06Q 40/08; G06V 10/761; G06V 2201/08

(57) ABSTRACT

A computer-implemented method comprises obtaining an image of a first damaged vehicle; selecting a set of images of second damaged vehicles that are similar to the first damaged vehicle; finding a set of images of the second vehicles showing damage similar to the damage to the first vehicle; obtaining a set of vehicle repair claims corresponding to the set of one or more images of the second vehicles; adding a selected subset to a repair estimate data structure; presenting a user interface that represents the selected subset of line items; receiving first user input that represents line items chosen by the user; generating a vector that represents the chosen line items; and applying the vector to a trained machine learning model, wherein the trained machine learning model outputs a refined subset of line items.

### CROSS REFERENCE TO RELATED APPLICATIONS

The present application claims priority to U.S. Provisional Patent Application No. 63/405,766, filed Sep. 12, 2022, entitled “VEHICLE REPAIR ESTIMATION WITH REVERSE IMAGE MATCHING AND ITERATIVE VECTORIZED CLAIM REFINEMENT,” the disclosure thereof incorporated by reference herein in its entirety.

### DESCRIPTION OF RELATED ART

The disclosed technology relates generally to estimates for vehicle repair, and more particularly some embodiments relate to automatically assisting the generation of cost estimates for vehicle repair.

### SUMMARY

In general, one aspect disclosed features a system, comprising: a hardware processor; and a non-transitory machine-readable storage medium encoded with instructions executable by the hardware processor to perform operations comprising: obtaining an image of a first damaged vehicle; selecting a set of images of second damaged vehicles that are similar to the first damaged vehicle; finding a set of one or more images of the second vehicles showing damage similar to the damage to the first vehicle; obtaining a set of vehicle repair claims corresponding to the set of one or more images of the second vehicles; selecting a subset of line items from the set of vehicle repair claims; adding the selected subset of line items to a repair estimate data structure for the first damaged vehicle; generating a user interface for presentation to a user on a user device, wherein the user interface includes display elements that represent the selected subset of line items in the repair estimate data structure; receiving first user input from the user interface, wherein the first user input represents line items that are chosen by the user; generating a vector that represents the line items chosen by the user; applying the vector as an inference input to a trained machine learning model that has been trained with correspondences between historical examples of the vectors and corresponding line items, wherein responsive to the inference input, the trained machine learning model outputs a refined subset of line items; modifying the repair estimate data structure to include the refined subset of line items; and presenting a view of the modified repair estimate data structure in the user interface.

Embodiments of the system may include one or more of the following features. In some embodiments, the operations further comprise: receiving second user input from the user interface, wherein the second user input represents a decision by the user to commit the estimate; and responsive to the second user input, providing the modified repair estimate data structure to a claims adjuster. In some embodiments, the operations further comprise: finding one or more images of the other damaged vehicles that are similar to the image of the damaged vehicle comprises: reverse searching the selected set of images of other damaged vehicles using the image of the damaged vehicle. In some embodiments, selecting a subset of line items from the obtained vehicle repair claims comprises: selecting line items based on a frequency of occurrence of the line items. In some embodiments, the operations further comprise: obtaining one or more training data sets comprising the historical examples of the vectors and corresponding line items; and training the one or more trained machine learning models using the training data set. In some embodiments, the operations further comprise: generating the one or more training data sets. In some embodiments, the operations further comprise: obtaining one or more further training data sets comprising further historical examples of the vectors and corresponding line items; and retraining the one or more trained machine learning models using the further training data set.

In general, one aspect disclosed features one or more non-transitory machine-readable storage media encoded with instructions that, when executed by one or more hardware processors of a computing system, cause the computing system to perform operations comprising: obtaining an image of a first damaged vehicle; selecting a set of images of second damaged vehicles that are similar to the first damaged vehicle; finding a set of one or more images of the second vehicles showing damage similar to the damage to the first vehicle; obtaining a set of vehicle repair claims corresponding to the set of one or more images of the second vehicles; selecting a subset of line items from the set of vehicle repair claims; adding the selected subset of line items to a repair estimate data structure for the first damaged vehicle; generating a user interface for presentation to a user on a user device, wherein the user interface includes display elements that represent the selected subset of line items in the repair estimate data structure; receiving first user input from the user interface, wherein the first user input represents line items that are chosen by the user; generating a vector that represents the line items chosen by the user; applying the vector as an inference input to a trained machine learning model that has been trained with correspondences between historical examples of the vectors and corresponding line items, wherein responsive to the inference input, the trained machine learning model outputs a refined subset of line items; modifying the repair estimate data structure to include the refined subset of line items; and presenting a view of the modified repair estimate data structure in the user interface.

Embodiments of the one or more non-transitory machine-readable storage media may include one or more of the following features. In some embodiments, the operations further comprise: receiving second user input from the user interface, wherein the second user input represents a decision by the user to commit the estimate; and responsive to the second user input, providing the modified repair estimate data structure to a claims adjuster. In some embodiments, the operations further comprise: finding one or more images of the other damaged vehicles that are similar to the image of the damaged vehicle comprises: reverse searching the selected set of images of other damaged vehicles using the image of the damaged vehicle. In some embodiments, selecting a subset of line items from the obtained vehicle repair claims comprises: selecting line items based on a frequency of occurrence of the line items. In some embodiments, the operations further comprise: obtaining one or more training data sets comprising the historical examples of the vectors and corresponding line items; and training the one or more trained machine learning models using the training data set. In some embodiments, the operations further comprise: generating the one or more training data sets. In some embodiments, the operations further comprise: obtaining one or more further training data sets comprising further historical examples of the vectors and corresponding line items; and retraining the one or more trained machine learning models using the further training data set.

In general, one aspect disclosed features a computer-implemented method comprising: obtaining an image of a first damaged vehicle; selecting a set of images of second damaged vehicles that are similar to the first damaged vehicle; finding a set of one or more images of the second vehicles showing damage similar to the damage to the first vehicle; obtaining a set of vehicle repair claims corresponding to the set of one or more images of the second vehicles; selecting a subset of line items from the set of vehicle repair claims; adding the selected subset of line items to a repair estimate data structure for the first damaged vehicle; generating a user interface for presentation to a user on a user device, wherein the user interface includes display elements that represent the selected subset of line items in the repair estimate data structure; receiving first user input from the user interface, wherein the first user input represents line items that are chosen by the user; generating a vector that represents the line items chosen by the user; applying the vector as an inference input to a trained machine learning model that has been trained with correspondences between historical examples of the vectors and corresponding line items, wherein responsive to the inference input, the trained machine learning model outputs a refined subset of line items; modifying the repair estimate data structure to include the refined subset of line items; and presenting a view of the modified repair estimate data structure in the user interface.

Embodiments of the method may include one or more of the following features. Some embodiments comprise receiving second user input from the user interface, wherein the second user input represents a decision by the user to commit the estimate; and responsive to the second user input, providing the modified repair estimate data structure to a claims adjuster. In some embodiments, finding one or more images of the other damaged vehicles that are similar to the image of the damaged vehicle comprises: reverse searching the selected set of images of other damaged vehicles using the image of the damaged vehicle. Some embodiments comprise selecting a subset of line items from the obtained vehicle repair claims comprises: selecting line items based on a frequency of occurrence of the line items. Some embodiments comprise obtaining one or more training data sets comprising the historical examples of the vectors and corresponding line items; and training the one or more trained machine learning models using the training data set. Some embodiments comprise generating the one or more training data sets.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a vehicle repair estimation system according to some embodiments of the disclosed technology.

FIGS. 2A,B are a flowchart illustrating a process for vehicle repair estimation with reverse image matching and iterative vectorized claim refinement according to some embodiments of the disclosed technologies.

FIG. 3 depicts an example user interface showing both the image of the claim vehicle and images of other damaged vehicles according to some embodiments of the disclosed technology.

FIG. 4 depicts an example user interface showing the selected line items from similar matched claims.

FIG. 5 depicts a flowchart for a process 500 according to some embodiments of the disclosed technologies.

FIG. 6 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technologies provide vehicle repair estimation with reverse image matching and iterative vectorized claim refinement. These embodiments create more accurate repair estimates than prior solutions, and create those estimates more quickly and with less labor than prior solutions.

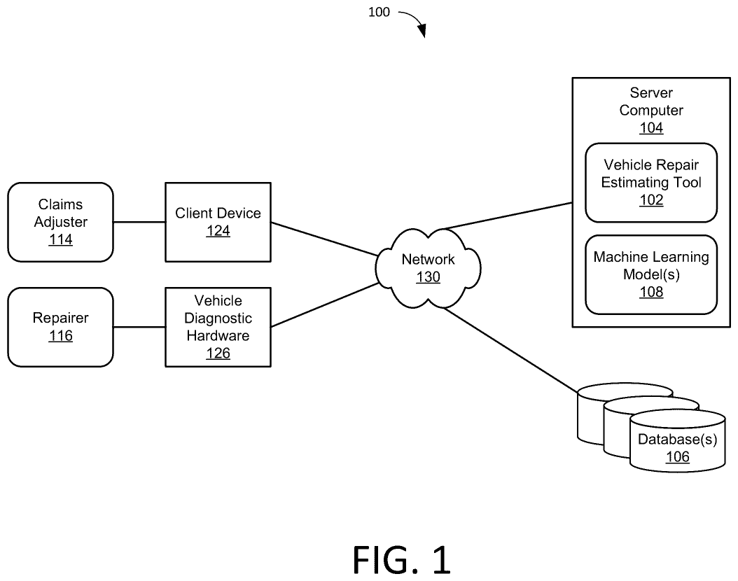

FIG. 1 illustrates a vehicle repair estimation system 100 according to some embodiments of the disclosed technology. The system 100 may include a Vehicle Repair Estimating Tool 102. The tool 102 may be implemented as one or more software packages executing on one or more server computers 104. The tool 102 may include one or more machine learning models 108. The machine learning models 108 may be implemented in any manner. The machine learning models 108 may be implemented as trained machine learning models, for example as described below. The system 100 may include one or more databases 106. In some embodiments, the databases 106 may store rules for execution by the tool 102. In some embodiments, the databases 106 may store electronic vehicle repair estimate records and related images of damaged vehicles.

Multiple users may interact with the tool 102. For example, referring to FIG. 1, the users may include a claims adjuster 114, a vehicle repairer 116, and the like. Each user may employ a respective device or system. The claims adjuster 114 may employ a client device 124. The repairer 116 may employ vehicle scanning hardware 126. Each device may be implemented as a computer, smart phone, smart glasses, electronic embedded computers and displays, and the like. Each user may employ the client device or hardware to access the tool 102 over a network 130 such as the Internet.

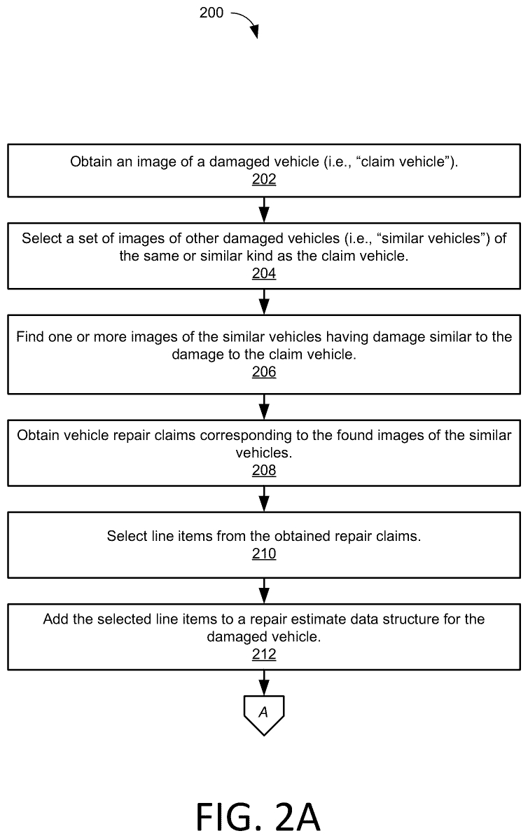

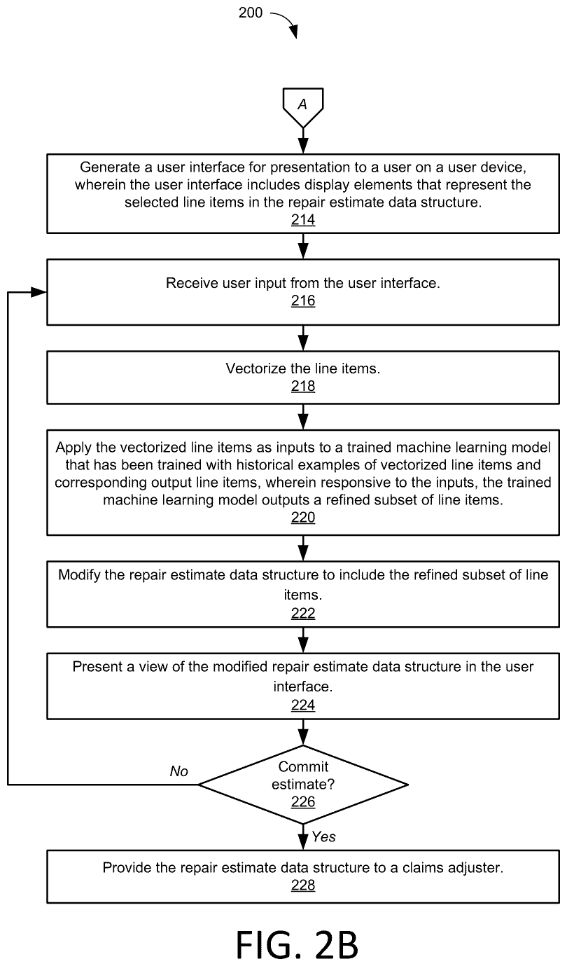

FIGS. 2A,B are a flowchart illustrating a process 200 for vehicle repair estimation with reverse image matching and iterative vectorized claim refinement according to some embodiments of the disclosed technologies. The elements of the process 200 are presented in one arrangement. However, it should be understood that one or more elements of the process may be performed in a different order, in parallel, omitted entirely, and the like. Furthermore, the process 200 may include other elements in addition to those presented. For example, the process 200 may include error-handling functions if exceptions occur, and the like. Portions of the process 200 may be performed by the Vehicle Repair Estimating Tool 102.

Referring to FIG. 2A, the process 200 may include obtaining one or more images of a damaged vehicle, sometimes referred to herein for clarity as the “claim vehicle”, at 202. However, some or all of the images may be unrelated to any insurance claim. In the example of FIG. 1, the image(s) of the claim vehicle may be obtained from the database(s) 106. Some or all of the images may come from other sources. For example, some or all of the images may be supplied by the claims adjuster 114 and/or the repairer 116. The images may include photographs or other scans of the claim vehicle. While the disclosed technologies are described as using images, it should be understood that videos or other moving images may be used in addition to, or instead of, still images.

Referring again to FIG. 2A, the process 200 may include selecting a set of images of other damaged vehicles of the same or similar kind as the claim vehicle, at 204. In the example of FIG. 1, the images of the other damaged vehicles may be obtained from the database(s) 106. The images may include photographs, other scans, and moving images. Selecting other damaged vehicles of the same kind as the claim vehicle may be based on any vehicle parameters. For example, the vehicle parameters may include year, make, model, vehicle identification number (VIN), and similar parameters.

Referring again to FIG. 2A, the process 200 may include finding images of similar vehicles showing damage similar to that of the claim vehicle, at 206. In some embodiments, finding these images may include conducting a reverse image search of the selected set of images using one or more of the obtained images of the claim vehicle. Any reverse image search technique may be employed to find these images.

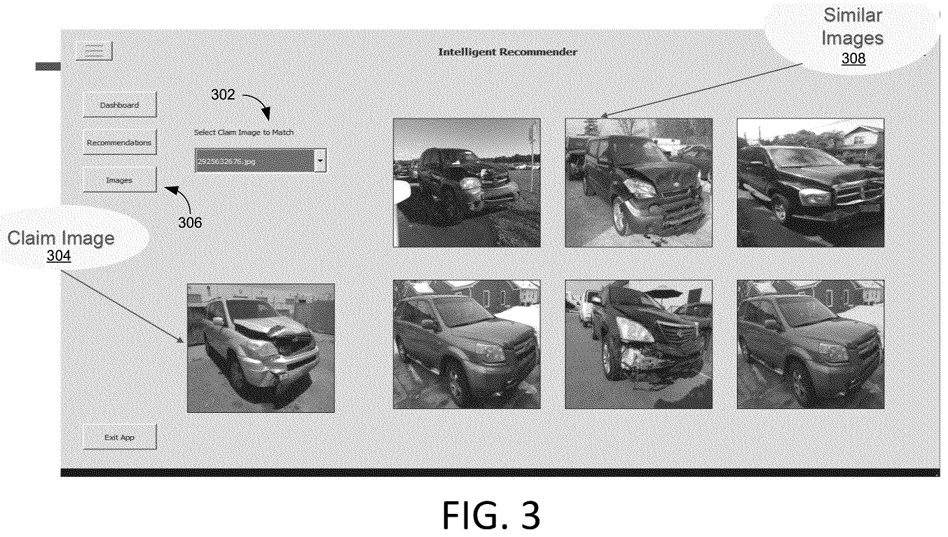

The set of images of the other damaged vehicles may be presented to a user in a user interface so the user may refine the set of the images. FIG. 3 depicts an example user interface showing both the image of the claim vehicle and images of other damaged vehicles according to some embodiments of the disclosed technology. Referring to FIG. 3, the user interface may include an active display element 302 operable to select an image of the claim vehicle. The user interface may include a display area 304 to present the selected image of the claim vehicle, referred to as the “claim image”. The user interface may include an active display element 306 operable to find the images of similar vehicles having similar damage, referred to herein as “similar images”. The user interface may also include a display area 308 to present the similar images.

Referring again to FIG. 2A, the process 200 may include obtaining vehicle repair claims corresponding to the found images of the similar vehicles, at 208. The vehicle repair claims may be stored in association with the similar images in database(s) 106, and may be obtained using these associations. Each claim may have one or more line items. Each line item may describe a vehicle repair operation such as repairing, replacing, and/or repainting damaged vehicle parts.

The process 200 may include selecting a subset of the line items in the obtained vehicle repair claims, at 210. Any technique may be used to select this subset. Preferably the technique employed selects a subset having a high relevance to the damage to the claim vehicle. For example, the tool 102 may select those line items that occur with high frequency in the obtained vehicle repair claims. In some embodiments, confidence factors are associated with the line items, and are used to select the subset. Other suitable techniques may include ranking, voting, thresholding, and similar techniques. For example, the tool 102 may select only a predetermined number of the highest-ranked estimate line items from the obtained vehicle repair claims. In some embodiments, this process may employ trained machine learning models. The models may be trained with historical examples of vehicle repair claims and corresponding selected line items.

In some embodiments, these automated techniques may be used in addition to, or instead of, a manual selection process where the tool 102 receives input representing selected line items from a user interface operated by a user. The process 200 may include adding the selected subset of line items to a repair estimate data structure for the damaged vehicle, at 212.

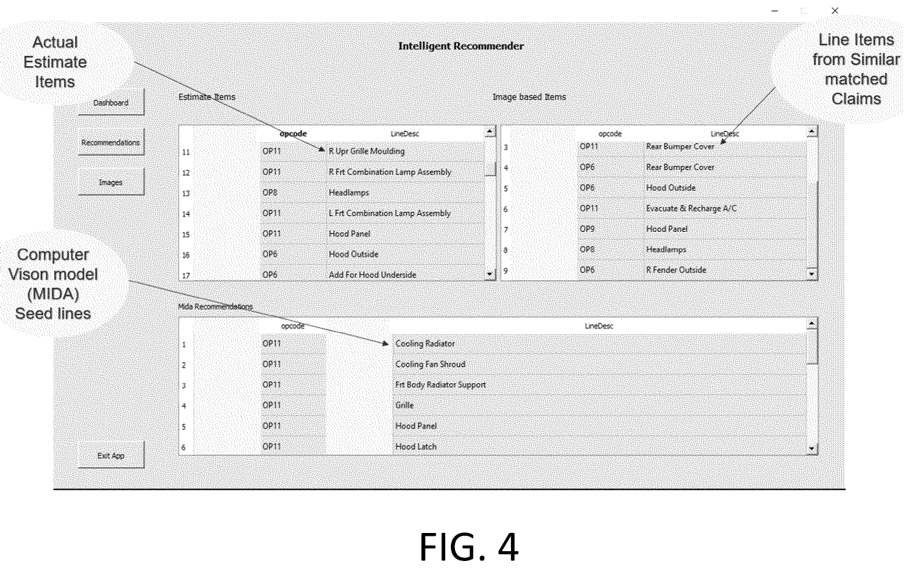

Referring now to FIG. 2B, the process 200 may include generating a user interface for presentation to a user on a user device, at 214. The user interface may include display elements that represent the selected line items in the repair estimate data structure, The user interface may include active display elements operable by a user to add, remove, or confirm individual line items. FIG. 4 depicts an example user interface showing the selected line items from similar matched claims.

Referring again to FIG. 2B, the process 200 may include receiving user input from the user interface, at 216. The user input may represent line items that are recommended by the tool 102 and chosen by the user. The user input may represent line items that are added by the user. The process 200 may include vectorizing the chosen and/or added line items, at 218. In some embodiments, each potential line item of a claim may be represented in a N-dimensional “one-hot encoding” style vector. That is, the value of each element of the vector is either 0 or 1 and represents the non-presence or presence of a line item in the vehicle repair estimate data structure. The length N is determined by the vehicle type, as different vehicle types have different quantities of potential line items. Therefore, the magnitude of the vector scales with the number of line items added to the estimate. In some embodiments, the one-hot vectors may be encoded or compressed to reduce the processing resources required to process the vectors. For example, a one-hot vector may be represented by an integer representing an index of the one-hot vector element. Other vector encoding techniques may be used. For example, multiple-hot vectors may be used, where multiple vector elements may be hot.

In some embodiments, line items considered may be limited in accordance with practical constraints to only those line items considered to be “in scope” for the vehicle type. The term “in scope” refers to line items which have been determined likely applicable to a particular vehicle type, while line items that are “out of scope” likely do not apply to that vehicle type. This filtering may reduce the possible quantity of line items to a more manageable number. For example, while the total number of line items for all vehicles is estimated at 500,000, the number of “in scope” line items for a particular vehicle type may be approximately 2,000. In some embodiments, what is in-scope may be determined through the use of a frequency gate. As a particular example, in-scope line items may be those that appear in more than a predetermined percentage of claims for vehicles of the vehicle type. In one example, the predetermined percentage may be 0.14%.

In some embodiments, the line items considered may be limited in accordance with business rules. The business rules may be established by particular customers such as insurers. For example, a particular customer may not wish to see line items related to repainting in estimates they receive.

In some embodiments, the line items considered may be limited by particular implementations. For example, repair/replace decisions may be implemented in a first application while repainting decisions may be implemented in a second application. In this example, line items concerning repainting decisions should not be considered in the first application, and line items concerning repair/replace decisions should not be considered in the second application.

The process 200 may include applying the vectorized line items as inputs to a trained machine learning model that has been trained with historical examples of vectorized line items and corresponding output line items, wherein responsive to the inputs, the trained machine learning model outputs a refined subset of line items, at 220. In some embodiments, rules-based filtering may be applied to the output line items. For example, content rules may be employed to filter out line items previously rejected by the user and/or to filter the line items according to application implementation structures. As another example, business rules may be applied to filter the line items according to client requirements, for example as described above. In some embodiments, the number of line items presented in the user interface may be limited to a predetermined number. For example, the line items may be ranked, with only the top-ranked five line items presented in the user interface.

The process 200 may include modifying the repair estimate data structure to include the refined subset of line items, at 222, and presenting a view of the modified repair estimate data structure in the user interface, at 224. The user may choose whether to continue to modify the estimate or to accept the refined subset of line items by committing the estimate, at 226. When the user chooses to continue to modify the estimate, a portion of the process 200 may repeat, returning to 216. When the user chooses to commit the estimate, the process 200 may include providing the repair estimate data structure to a claims adjuster, at 228. The repair estimate data structure includes the refined set of line items. In the example of FIG. 1, the user interface may be presented to the claims adjuster 114 by the client device 124, to the repairer 116 by the vehicle scanning hardware 126 or another device, to other users with other devices, or any combination thereof.

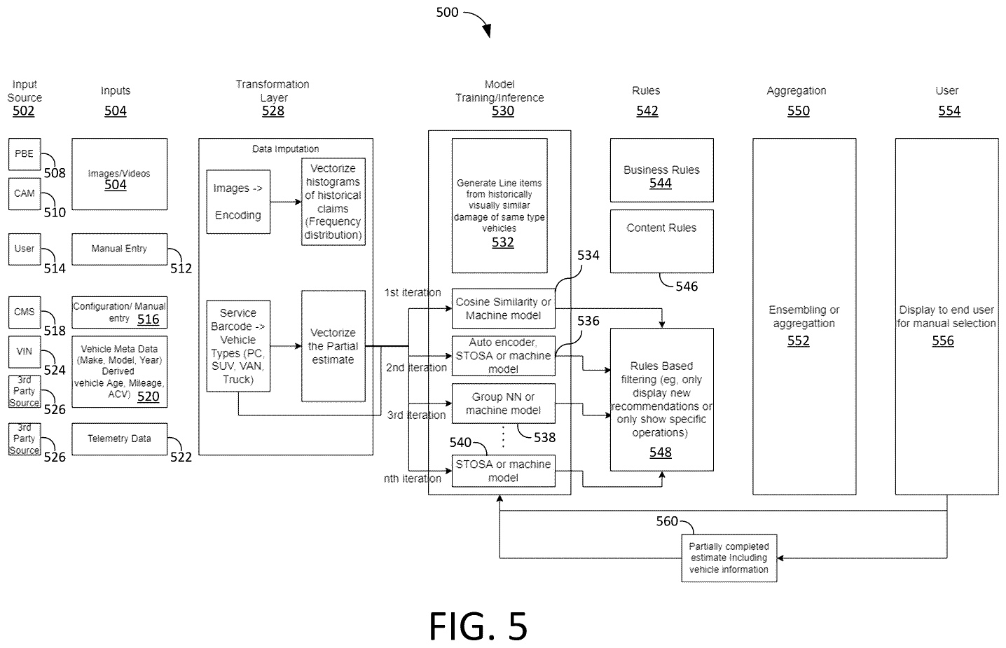

FIG. 5 depicts a flowchart for a process 500 according to some embodiments of the disclosed technologies. Referring to FIG. 5, the process 500 may begin with inputs 504 from input sources 502. The inputs 504 may include images and/or videos 506 provided by sources such as photo-based estimating (PBE) 508 and software mechanisms such as a Claim Attachment Manager (CAM) 510 for intake of attachments such as pictures, videos, and documents for a given claim. The inputs 504 may include manual entries 512 provided by a user 514. The inputs 504 may include configuration and manual entries 516 provided by a claims management system (CMS) 518. The inputs 504 may include vehicle metadata 520 and telemetry data 522 which may be derived from the vehicle identification number (VIN) 524 and third-party sources 526. For example, the vehicle metadata may include year, make, model, derived vehicle age, mileage, actual cash value, and similar metadata.

The process 500 may include a transformation layer 528, which may include image matching and estimate line item vectorization, for example as described above. The process 500 may include model training and inference 530, for example as described herein. This stage may include generating line items from historically visually similar damage to the same type of vehicle, at 532. This stage may also employ an iterative inference process. Different iterations may employ the same trained machine learning model and/or different trained machine learning models. In the example of FIG. 5, the first iteration may employ a cosine similarity or machine model 534. The second iteration may employ an auto encoder, stochastic self-attention (STOSA) model, or machine model 536. The third iteration may employ a group NN or machine model 538. Subsequent iterations may employ a STOSA or machine model 540. The models in the model training/inference stage of FIG. 5 may be selected on the basis of not only the iteration number, but also and jointly on the basis of vehicle type.

A rules stage 542 may follow. In this stage, business rules 544, content rules 546, and filtering 548 may be applied to the outputs of the model training/inference stage 530. In an aggregation stage 550, the resulting line items may be ensembled or aggregated at 552. In a user stage 554, the ensembled or aggregated line items may be presented to a user for manual selection, at 556. The tool 102 may allow the user to iterate the model training/inference stage 530, rules stage 540, aggregation stage 550, and user stage 554 by passing a partially-completed estimate including vehicle information 560 to the model training/inference stage 530 until the user commits the estimate.

In some embodiments, the disclosed technologies may include the use of one or more trained machine learning models at one or more points in the described processes. Any machine learning models may be used. For example, the machine learning models and techniques may include classifiers, generative models, discriminative models, decision trees, neural networks, gradient boosting, and similar machine learning models and techniques. The machine learning models may be trained previously according to historical correspondences between inputs and corresponding outputs. Once the machine learning models have been trained, new inputs may be applied to the trained machine learning model as inputs. In response, the machine learning models may provide the desired outputs.

The neural network may include a feature extraction layer that extracts features from the input data. In some embodiments, this process may be performed after input data preprocessing. The preprocessing may include input data transformation. The input data transformation may include converting different file types (e.g., image format, word format, etc.) into a unified digital format (e.g., pdf file). The preprocessing may include data extraction. The data extraction may include extracting useful information, for example using optical character recognition (OCR) and natural language processing (NLP) techniques.

The feature extraction in the feature extraction layer may be performed against the extracted data. The features for extraction may include the vectorized line items described above. The features for extraction may include an indicator of whether the estimate is original or is a supplement (that is, a revised version of the original estimate). The selection of the features for extraction may also be determined by learning importance scores for the candidate features using a tree-based machine learning model. Features may be extracted outside of data transformation and feature extraction. For example, vehicle metadata may be extracted via VIN decode or may be provided directly.

For example, the tree-based machine learning model for feature selection may use Random Forests or Gradient Boosting. The model includes an ensemble of decision trees that collectively make predictions. To begin, the tree-based model may be trained on a labeled dataset. The dataset may include historical examples of vectorized line items and corresponding output line items, wherein responsive to the inputs, the trained machine learning model outputs a refined subset of line items. The historical output line items may be used as the ground truth labels for training purposes.

As the tree-based machine learning model learns to make predictions, it recursively splits the data based on different features, constructing a tree structure that captures patterns in the data. The goal of the training is to make the predictions as close to the ground truth labels as possible. One of the advantages of tree-based models is that they can generate feature importance scores for each input feature. These scores reflect the relative importance of each feature in contributing to the model's predictive power. A higher importance score indicates that a feature has a greater influence on the model's decision-making process.

In some embodiments, Gini importance metric may be used for feature importance in the tree-based model. Gini importance quantifies the total reduction in the Gini impurity achieved by each feature across all the trees in the ensemble. Features that lead to a substantial decrease in impurity when used for splitting the data are assigned higher importance scores.

Once the tree-based model is trained, the feature importance scores may be extracted. By sorting the features in descending order based on their scores, a ranked list of features may be obtained. This ranking enables prioritizing the features that have the most impact on the model's decision-making process.

Based on the feature ranking, the top features may be extracted from incoming vectorized line items and fed into the neural network to predict the electronic vehicle diagnostic records that should be selected.

The neural network may include an output layer that provides output data based on the input data. For example, the output layer of a classifier may use a sigmoid activation function that outputs a probability value between 0 and 1 for each class.

For example, portions of the processes described above for the Vehicle Repair Estimating Tool 102 may be implemented using a trained machine learning model. The model may be trained using training data that reflect historical vectorized line items and corresponding output line items. In some embodiments, the training data may include scores and weights of these records, as well as thresholds employed with the scoring.

During inference operation, vectorized line items may be provided as inference input data to a trained machine learning model. An input layer of the model may extract one or more parameters as input data from the electronic records. Responsive to the inference input, an output layer of the model may provide output representing a selection probability for each output line item.

Some embodiments include the training of the machine learning models. The training may be supervised, unsupervised, or a combination thereof, and may continue between operations for the lifetime of the system. The training may include creating a training set that includes the input parameters and corresponding assessments described above.

The training may include one or more second stages. A second stage may follow the training and use of the trained machine learning models, and may include creating a second training set, and training the trained machine learning models using the second training set. The second training set may include the inputs applied to the machine learning models, and the corresponding outputs generated by the machine learning models, during actual use of the machine learning models.

The second training stage may include identifying erroneous assessments generated by the machine learning model, and adding the identified erroneous assessments to the second training set. Creating the second training set may also include adding the inputs corresponding to the identified erroneous assessments to the second training set.

For example, the training may include supervised learning with labeled training data (e.g., historical inference input may be labeled with “automatic” or “manual” for training purposes). The training may be performed iteratively. The training may include techniques such as forward propagation, loss function, backpropagation for calculating gradients of the loss, and updating weights for each input.

The training may involve extracting data features (for example vehicle attributes) and further binning and/or categorizing different classes like vehicle types (for example SUV, Van, Truck, Passenger Car [PC] or subsets of PCs, etc.) Further rules may be applied to the training data to maintain a specific version of the historical claims (for example, maintaining data by associated final supplement version). Additional rules may be applied like exclusion to claim lines that are frequently included as result of auto-inclusion rules.

In the event that training data may not carry sequential information (that is time based and/or defined order of including line items to a claim), the training data may be further imputed to include synthesized versions of sequence information. That sequence may be further used in training of the sequence models, for example in STOSA approach.

The training may include a stage to initialize the model. This stage may include initializing parameters of the model, including weights and biases, and may be performed randomly or using predefined values. The initialization process may be customized to suit the type of model.

The training may include a forward propagation stage. This stage may include a forward pass through the model with a batch of training data. The input data may be multiplied by the weights, and biases may be added at each layer of the model. Activation functions may be applied to introduce non-linearity and capture complex relationships.

The training may include a stage to calculate loss. This stage may include computing a loss function that is appropriate for binary classification, such as binary cross-entropy or logistic loss. The loss function may measure the difference between the predicted output and the actual binary labels.

The training may include a backpropagation stage. Backpropagation involves propagating error backward through the network and applying the chain rule of derivatives to calculate gradients efficiently. This stage may include calculating gradients of the loss with respect to the model's parameters. The gradients may measure the sensitivity of the loss function to changes in each parameter.

The training may include a stage to update weights of the model. The gradients may be used to update the model's weights and biases, aiming to minimize the loss function. The update may be performed using an optimization algorithm, such as stochastic gradient descent (SGD) or its variants (e.g., Adam, RMSprop). The weights may be adjusted by taking a step in the opposite direction of the gradients, scaled by a learning rate.

The training may iterate. The training process may include multiple iterations or epochs until convergence is reached. In each iteration, a new batch of training data may be fed through the model, and the weights adjusted based on the gradients calculated from the loss.

The training may include a model evaluation stage. Here, the model's performance may be evaluated using a separate validation or test dataset. The evaluation may include monitoring metrics such as accuracy, precision, recall, and mean squared error to assess the model's generalization and identify possible overfitting.

The training may include stages to repeat and fine-tune the model. These stages may include adjusting hyperparameters (e.g., learning rate, regularization) based on the evaluation results and iterating further to improve the model's performance. The training can continue until convergence, a maximum number of iterations, or a predefined stopping criterion.

As a particular example, the machine learning models may be used to populate the fields of the repair estimate data structure. In this example, the training data set(s) may include correspondences between field values and field identifiers of the repair estimate data structure.

Embodiments of the disclosed technologies provide numerous advantages. For example, marked gains in cycle time efficiency are achieved. The advantages also include a more engaged user experience with reduced error rates resulting in highly accurate estimate write ups, and higher agreement rates when validating predictions prior to populating and committing to the estimate. These features allow an organized approach towards straight through processing of qualified (low touch) claims.

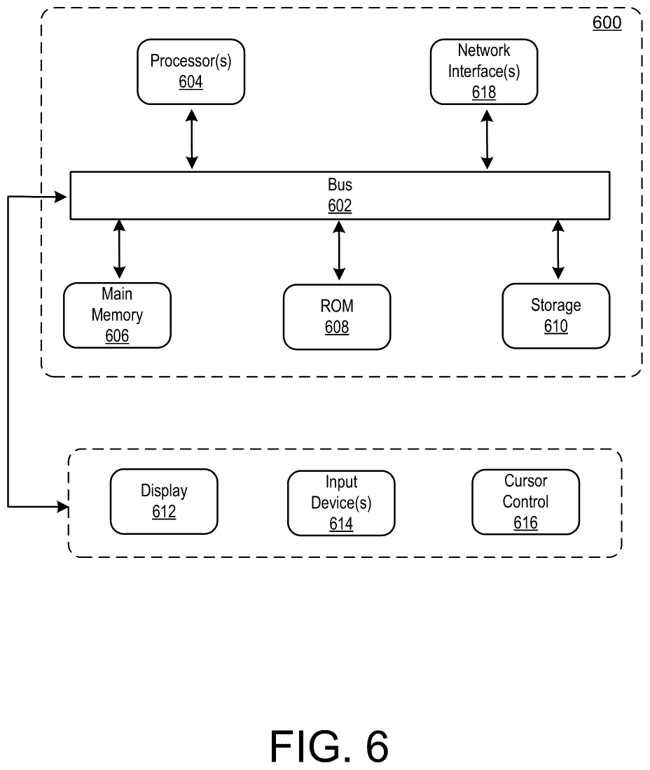

FIG. 6 depicts a block diagram of an example computer system 600 in which embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or a WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A system, comprising:
a hardware processor; and
a non-transitory machine-readable storage medium encoded with instructions executable by the hardware processor to perform operations comprising:
obtaining an image of a first damaged vehicle;
selecting a set of images of second damaged vehicles that are similar to the first damaged vehicle;
finding a set of one or more images of the second vehicles showing damage similar to the damage to the first vehicle;
obtaining a set of vehicle repair claims corresponding to the set of one or more images of the second vehicles;
selecting a subset of line items from the set of vehicle repair claims;
adding the selected subset of line items to a repair estimate data structure for the first damaged vehicle;
generating a user interface for presentation to a user on a user device, wherein the user interface includes display elements that represent the selected subset of line items in the repair estimate data structure;
receiving first user input from the user interface, wherein the first user input represents line items that are chosen by the user;
generating a vector that represents the line items chosen by the user;
applying the vector as an inference input to a trained machine learning model that has been trained with correspondences between historical examples of the vectors and corresponding line items, wherein responsive to the inference input, the trained machine learning model outputs a refined subset of line items;
modifying the repair estimate data structure to include the refined subset of line items; and
presenting a view of the modified repair estimate data structure in the user interface.

2. The system of claim 1, the operations further comprising:
receiving second user input from the user interface, wherein the second user input represents a decision by the user to commit the estimate; and
responsive to the second user input, providing the modified repair estimate data structure to a claims adjuster.

3. The system of claim 1, the operations further comprising:
finding one or more images of the other damaged vehicles that are similar to the image of the damaged vehicle comprises:
reverse searching the selected set of images of other damaged vehicles using the image of the damaged vehicle.

4. The system of claim 1, the operations further comprising:
selecting a subset of line items from the obtained vehicle repair claims comprises:
selecting line items based on a frequency of occurrence of the line items.

5. The system of claim 1, the operations further comprising:
obtaining one or more training data sets comprising the historical examples of the vectors and corresponding line items; and
training the one or more trained machine learning models using the training data set.

6. The system of claim 5, the operations further comprising:
generating the one or more training data sets.

7. The system of claim 5, the operations further comprising:
obtaining one or more further training data sets comprising further historical examples of the vectors and corresponding line items; and
retraining the one or more trained machine learning models using the further training data set.

8. One or more non-transitory machine-readable storage media encoded with instructions that, when executed by one or more hardware processors of a computing system, cause the computing system to perform operations comprising:
obtaining an image of a first damaged vehicle;
selecting a set of images of second damaged vehicles that are similar to the first damaged vehicle;
finding a set of one or more images of the second vehicles showing damage similar to the damage to the first vehicle;
obtaining a set of vehicle repair claims corresponding to the set of one or more images of the second vehicles;
selecting a subset of line items from the set of vehicle repair claims;
adding the selected subset of line items to a repair estimate data structure for the first damaged vehicle;
generating a user interface for presentation to a user on a user device, wherein the user interface includes display elements that represent the selected subset of line items in the repair estimate data structure;
receiving first user input from the user interface, wherein the first user input represents line items that are chosen by the user;
generating a vector that represents the line items chosen by the user;
applying the vector as an inference input to a trained machine learning model that has been trained with correspondences between historical examples of the vectors and corresponding line items, wherein responsive to the inference input, the trained machine learning model outputs a refined subset of line items;
modifying the repair estimate data structure to include the refined subset of line items; and
presenting a view of the modified repair estimate data structure in the user interface.

9. The one or more non-transitory machine-readable storage media of claim 8, the operations further comprising:
receiving second user input from the user interface, wherein the second user input represents a decision by the user to commit the estimate; and
responsive to the second user input, providing the modified repair estimate data structure to a claims adjuster.

10. The one or more non-transitory machine-readable storage media of claim 8, the operations further comprising:
finding one or more images of the other damaged vehicles that are similar to the image of the damaged vehicle comprises:
reverse searching the selected set of images of other damaged vehicles using the image of the damaged vehicle.

11. The one or more non-transitory machine-readable storage media of claim 8, the operations further comprising:
selecting a subset of line items from the obtained vehicle repair claims comprises:
selecting line items based on a frequency of occurrence of the line items.

12. The one or more non-transitory machine-readable storage media of claim 8, the operations further comprising:
obtaining one or more training data sets comprising the historical examples of the vectors and corresponding line items; and
training the one or more trained machine learning models using the training data set.

13. The one or more non-transitory machine-readable storage media of claim 12, the operations further comprising:
generating the one or more training data sets.

14. The one or more non-transitory machine-readable storage media of claim 12, the operations further comprising:
obtaining one or more further training data sets comprising further historical examples of the vectors and corresponding line items; and
retraining the one or more trained machine learning models using the further training data set.

15. A computer-implemented method comprising:
obtaining an image of a first damaged vehicle;
selecting a set of images of second damaged vehicles that are similar to the first damaged vehicle;
finding a set of one or more images of the second vehicles showing damage similar to the damage to the first vehicle;
obtaining a set of vehicle repair claims corresponding to the set of one or more images of the second vehicles;
selecting a subset of line items from the set of vehicle repair claims;
adding the selected subset of line items to a repair estimate data structure for the first damaged vehicle;
generating a user interface for presentation to a user on a user device, wherein the user interface includes display elements that represent the selected subset of line items in the repair estimate data structure;
receiving first user input from the user interface, wherein the first user input represents line items that are chosen by the user;
generating a vector that represents the line items chosen by the user;
applying the vector as an inference input to a trained machine learning model that has been trained with correspondences between historical examples of the vectors and corresponding line items, wherein responsive to the inference input, the trained machine learning model outputs a refined subset of line items;
modifying the repair estimate data structure to include the refined subset of line items; and
presenting a view of the modified repair estimate data structure in the user interface.

16. The computer-implemented method of claim 15, further comprising:
receiving second user input from the user interface, wherein the second user input represents a decision by the user to commit the estimate; and
responsive to the second user input, providing the modified repair estimate data structure to a claims adjuster.

17. The computer-implemented method of claim 15, further comprising:
finding one or more images of the other damaged vehicles that are similar to the image of the damaged vehicle comprises:
reverse searching the selected set of images of other damaged vehicles using the image of the damaged vehicle.

18. The computer-implemented method of claim 15, further comprising:
selecting a subset of line items from the obtained vehicle repair claims comprises:
selecting line items based on a frequency of occurrence of the line items.

19. The computer-implemented method of claim 15, further comprising:
obtaining one or more training data sets comprising the historical examples of the vectors and corresponding line items; and
training the one or more trained machine learning models using the training data set.

20. The computer-implemented method of claim 19, further comprising:
generating the one or more training data sets.
